(19) United States
(12) Patent Application Publication
(10) Pub. No.: US 2022/0323294 A1
(43) Pub. Date: Oct. 13, 2022

(54) SEXUAL STIMULATION DEVICE

(71) Applicant: Martin Tucker, Tarzana, CA (US)

(72) Inventor: Martin Tucker, Tarzana, CA (US)

(21) Appl. No.: 17/718,191

(22) Filed: Apr. 11, 2022

Related U.S. Application Data
(60) Provisional application No. 63/173,187, filed on Apr. 9, 2021.

(51) Int. Cl. A61H 19/00

(52) U.S. Cl. CPC A61H 19/44; A61H 19/50; A61H 2201/1642; A61H 2201/1685; A61H 2201/5097

(57) ABSTRACT

A sexual stimulation apparatus comprising a main body enclosing an internal motor, a first handle coupled to the main body, and is detachably coupled to a second handle, and a thrusting pole coupled longitudinally at one end to the main body and at other end to a phallic device attachment rod via an attachment point, wherein the thrusting pole is forced to move longitudinally with respect to the main body, towards the attachment point and thereby provides thrust to the phallic device attachment rod.

### CROSS-REFERENCE TO RELATED APPLICATION

This application claims the benefit of U.S. Provisional Patent Application Ser. No. 63/173,187 filed Apr. 9, 2021, titled “Sexual Stimulation Device,” and the subject matter thereof is incorporated herein by reference thereto.

### TECHNICAL FIELD

The present invention relates to a sexual stimulation device, and more specifically to multi-use phallic device.

### BACKGROUND ART

Sex toys and erotic sexual stimulation devices are abundant in the prior art. Some can be used without a partner, while some require a partner, but finding one that can easily be used with or without a partner is always desirable. Typically, for devices that can be used with or without a partner, you are usually sacrificing some features, at least when you use it one of the two ways. Devices that provide that horizontal movement of a phallic device usually requires a cumbersome device that needs two individuals to use properly, or at least two hands. Additionally, no prior art could be located that provides vibration to any type and/or shape of phallic device.

Therefore, there is a need for a sexual stimulation device that can be used with or without a partner, provides horizontal movement of a phallic device, along with vibration of the phallic device, is lightweight, and can be easily manipulated to provide maximum satisfaction to the user. The prior art invention overcomes the shortcoming contained in the prior art by providing a such a device that provides all of those features.

Certain embodiments of the invention have other steps or elements in addition to or in place of those mentioned above. The steps or element will become apparent to those skilled in the art from a reading of the following detailed description when taken with reference to the accompanying figures.

None of the prior art fully addresses the problems resolved by the present invention. The present invention overcomes these limitations contained in the prior art by providing a child restraint apparatus for children that is sturdy, reliable, easy to use, safe, and inexpensive.

### BRIEF DESCRIPTION OF THE DRAWINGS

FIG. 1 illustrates a perspective view of the sexual stimulation apparatus of the present invention;

FIG. 2 illustrates a perspective view of the sexual stimulation apparatus of the present invention without the second handle; and

FIG. 3 illustrates a perspective view of the sexual stimulation apparatus of the present invention on a stand.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures. The term “on” means that there is direct contact among elements.

The present invention provides a sexual stimulation device that has the ability to be used individually or with a partner.

The present invention provides a sexual stimulation apparatus comprising a main body enclosing an internal motor, a first handle coupled to the main body, and is detachably coupled to a second handle, and a thrusting pole coupled longitudinally at one end to the main body and at other end to a phallic device attachment rod via an attachment point, wherein the thrusting pole is forced to move longitudinally with respect to the main body, towards the attachment point and thereby provides thrust to the phallic device attachment rod.

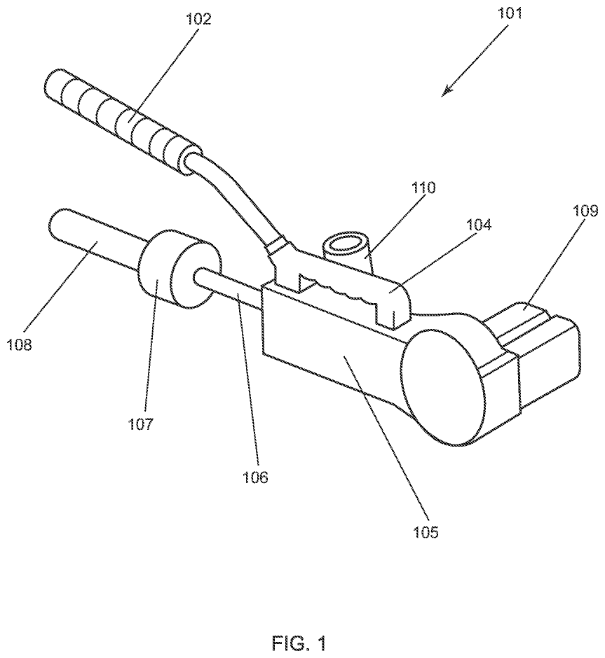

FIG. 1 is a perspective view of sexual stimulation apparatus 101. Sexual stimulation apparatus 101 comprises handle 104, second handle 102, thrusting pole 106, and main body 105. Phallic device attachment rod 108 is attached to attachment point 107. Attachment point 107 is attached to thrusting pole 106.

Main body 105 comprises an internal motor. The motor provides the thrusting of thrusting pole 106. The thrusting is horizontal in relation to the main body 105. Battery 109 is disposed on main body 105 and powers the motor. Controls are disposed on main body 105 or battery 109. Sexual stimulation apparatus 101 may also be operated wirelessly, or with other control device/option. Sexual stimulation apparatus 101 provides vibration to phallic device attachment rod 108 and is controlled by the user.

Attachment point 107 comprises a phallic device orientation nut that locks the phallic device attachment rod 108 into the desired orientation. The phallic device fits over the phallic device attachment rod 108 and is held in place with a vacuum lock.

Stand connection point 110 is rotatably disposed on main body 105.

Second handle 102 is extendable and can be easily removed and replaced. The positioning and length of second handle 102 allows for the user to more-easily use sexual stimulation apparatus 101 without a partner and manipulate the phallic device while in different positions, such as laying down. The controls for the vibrations and thrusting can be disposed on the second handle 102 to provide easy access. The second handle 102 allows for the user to position and hold the sexual stimulation apparatus 101 while in use.

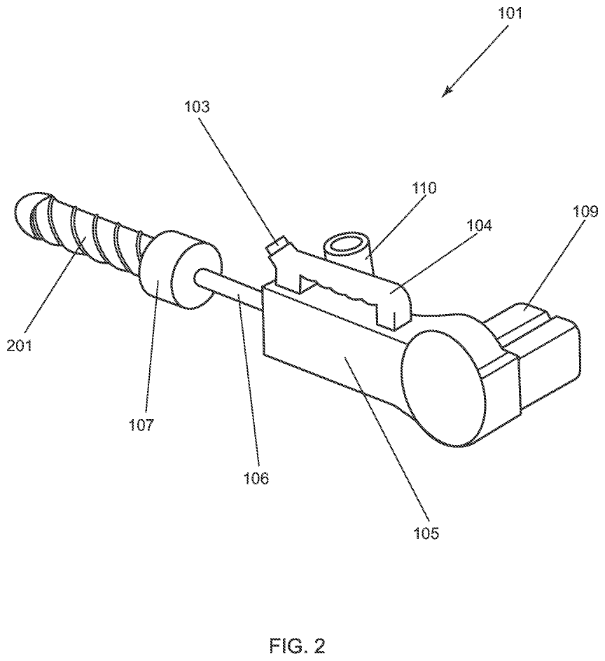

FIG. 2 shows a perspective view of the sexual stimulation apparatus 101 of the present invention without the second handle 102. Phallic device 201 is disposed on phallic device attachment rod 108. Phallic device 201 may be any type of sexual toys, including but not limited to, thrusting dildos, rabbit vibrators, strap-ons, vibrating panties, and cock cages.

Second handle 102 has been removed in FIG. 2. Second handle connection point 103 is visible. Second handle 102 can be detachably coupled to handle 104 via second handle connection point 103.

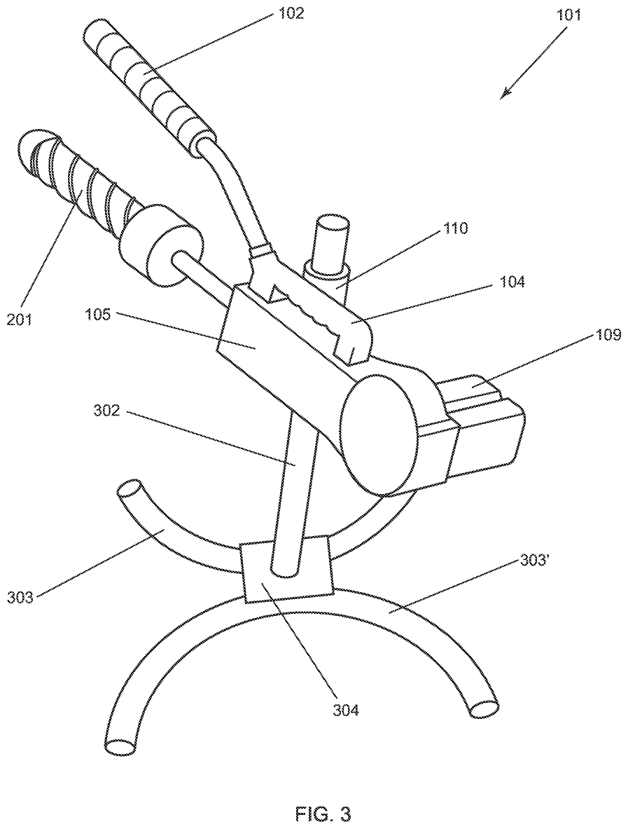

FIG. 3 shows a perspective view of the sexual stimulation apparatus 101 of the present invention on a stand. The stand is comprised of upright bar 302, which is removably attached to stand connection point 110, connection plate 304, and legs 303 and 303′. Upright bar 302 is retractable and extendable. When sexual stimulation apparatus 101 is disposed on the stand, the sexual stimulation apparatus 101 can be operated handsfree.

Sexual stimulation apparatus 101 can be moved vertically on upright bar of 302 and secured in place. The stand and second handle 102 allow sexual stimulation apparatus 101 to be easily used by one user.

The ability of sexual stimulation apparatus 101 to be angled at any angle both vertically and horizontally allows for maximum penetration and stimulation of the user. Stand connection point 110 is rotatably disposed on main body 105 and allows sexual stimulation apparatus 101 to be angled as desired by the user.

The amount of thrust provided by the thrusting pole 106 is controlled by the user with controls located on sexual stimulation apparatus 101, or other application that allows for the control of sexual stimulation apparatus 101. Additionally, there are various speeds that the user can select for the thrusting.

Although a phallic device has been shown, any type of sexual toy can be attached and used with the current invention.

Sexual stimulation apparatus 101 is lightweight and can easily be manipulated to provide maximum satisfaction to the user by adjusting the angle of penetration. This allows for one user to operate the sexual stimulation apparatus 101 using second handle 102.

In an alternative embodiment of the present invention, no arms are disposed on sexual stimulation apparatus 101.

In an alternative embodiment of the present invention, there is no battery and the sexual stimulation apparatus 101 is plugged into an external power source.

Controlling of the sexual stimulation apparatus 101 may be done with an external remote control or application that is either wired to the sexual stimulation apparatus 101 or wireless, via Bluetooth or other wireless options.

The best mode for carrying out the invention: has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A sexual stimulation apparatus comprising:
a main body enclosing an internal motor;
a first handle coupled to the main body, and is detachably coupled to a second handle; and
a thrusting pole coupled longitudinally at one end to the main body and at other end to a phallic device attachment rod via an attachment point, wherein the thrusting pole is forced to move longitudinally with respect to the main body, towards the attachment point and thereby provides thrust to the phallic device attachment rod.

2. The sexual stimulation apparatus of claim 1, wherein the internal motor is configured to provide thrusting of the thrusting pole in a horizontal direction with respect to the main body.

3. The sexual stimulation apparatus of claim 1, further comprises a battery disposed within the main body to provide power to the internal motor.

4. The sexual stimulation apparatus of claim 1, wherein the sexual stimulation apparatus is operated wirelessly or using other control device/option.

5. The sexual stimulation apparatus of claim 1, further comprises a phallic device mounted over the phallic device attachment rod, wherein the phallic device receives vibrations when the phallic device attachment rod receives thrust from the thrusting pole.

6. The sexual stimulation apparatus of claim 5, wherein the phallic device is fitted over the phallic device attachment rod and is held in place using a vacuum lock.

7. The sexual stimulation apparatus of claim 5, wherein the vibrations to the phallic device are controlled by a user.

8. The sexual stimulation apparatus of claim 1, further comprises a phallic device orientation nut to lock the phallic device attachment rod in a desired orientation.

9. The sexual stimulation apparatus of claim 1, wherein the second handle is extendable to allow a user to use the sexual stimulation apparatus without a partner and thereby manipulate a phallic device mounted on the phallic device attachment rod, while lying in different positions.

10. The sexual stimulation apparatus of claim 10, wherein control of the thrusting and the vibration is provided on the second handle to provide easy access for the user while lying in different positions.

11. A sexual stimulation apparatus comprising:
a main body enclosing an internal motor;
a first handle coupled to the main body, and is detachably coupled to a second handle;
a thrusting pole coupled longitudinally at one end to the main body and at other end to a phallic device attachment rod via an attachment point; and
a phallic device mounted onto the phallic device attachment rod, wherein the thrusting pole is forced to move longitudinally with respect to the main body, towards the attachment point to provide thrust to the phallic device attachment rod and thereby induce vibrations on the phallic device, wherein the second handle allows for the sexual stimulation apparatus to be used without a partner, by allowing a user to position and hold the sexual stimulation apparatus in different positions while in use.

12. The sexual stimulation apparatus of claim 11, further comprises a stand connection point rotatably disposed on the main body.

13. The sexual stimulation apparatus of claim 11, wherein the sexual stimulation apparatus is lightweight and easily manipulated to provide maximum satisfaction to a user by adjusting an angle of penetration.

14. A sexual stimulation apparatus comprising:
a main body enclosing an internal motor;
a first handle coupled to the main body, and is detachably coupled to a second handle;
a stand having an upright bar attached to a stand connection point of the main body at one end and to legs at other end using a connection plate, wherein the stand connection point is rotatably disposed on the main body;
a thrusting pole coupled longitudinally at one end to the main body and at other end to a phallic device attachment rod via an attachment point; and
a phallic device mounted onto the phallic device attachment rod, wherein the thrusting pole is forced to move longitudinally with respect to the main body, towards the attachment point to provide thrust to the phallic device attachment rod and thereby induce vibrations on the phallic device, wherein the stand connection point allows the sexual stimulation apparatus to be angled as desired by a user.

15. The sexual stimulation apparatus of claim 14, wherein the upright bar is removably attached to the stand connection point, the connection plate, and the legs.

16. The sexual stimulation apparatus of claim 14, wherein the upright bar is retractable and extendable and allows the sexual stimulation apparatus to move vertically on the upright bar.

17. The sexual stimulation apparatus of claim 14, wherein the stand and the second handle allow the sexual stimulation apparatus to be easily used by a user.

18. The sexual stimulation apparatus of claim 14, wherein the sexual stimulation apparatus is angled at any angle between vertically and horizontally to allow maximum penetration and stimulation of a user.

19. The sexual stimulation apparatus of claim 14, wherein the phallic device includes sexual toys, including thrusting dildos, rabbit vibrators, strap-ons, vibrating panties, and cock cages.

20. The sexual stimulation apparatus of claim 14, wherein the sexual stimulation apparatus is lightweight and easily manipulated to provide maximum satisfaction to a user by adjusting an angle of penetration.
